(19) United States
(12) Patent Application Publication
(10) Pub. No.: US 2008/0007574 A1
(43) Pub. Date: Jan. 10, 2008

(54) Image display method

(75) Inventors: Yutaka Yoshida, Tokyo (JP); Masayuki Kawata, Kanagawa (JP); Yasunori Ohta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/822,207

(22) Filed: Jul. 3, 2007

(30) Foreign Application Priority Data
Jul. 5, 2006 (JP) 2006-185390

(51) Int. Cl. G09G 5/10

(52) U.S. Cl. 345/690

(57) ABSTRACT

An image display method is provided, that enables a color display device to represent a gray image in medial use as a high definition display image suitable for diagnosis, by increasing the number of gradation levels that can be displayed. When displaying a monochrome image using a color display device having a pixel formed by R, G, and B cells, each luminance value for R, G, and B cells of the color device corresponding to a gray image to be displayed is determined, and the determined luminance value is used to drive the color display device to display the gray image.

The entire contents of documents cited in this specification are incorporated herein by reference.

### BACKGROUND OF THE INVENTION

The present invention generally relates to an image display method, and in particular to an image display method through which a color display device having a pixel formed by R, G, and B cells can display a gray image with higher reproducing capability, or in other words, a gray image can be displayed with multi-gradation gray levels (i.e., increased number of gray gradation levels).

In general, a diagnostic image captured by a medical diagnostic apparatus, such as X-ray diagnostic apparatus, MRI (magnetic resonance imaging) diagnostic apparatus, or CT (computerized tomography) device is recorded onto an image recording film of light transmissive, such as X-ray film or any other photosensitive film material, and reproduced as a light transmissive image. The film on which such diagnostic image is reproduced is then set on an X-ray film viewer, called as Schaukasten, so that the film is observed for diagnosis, while light is radiated from backside.

In many types of medical diagnosis/measurement apparatuses, a CRT display or LCD (liquid crystal display) is provided as a monitor for observing the obtained image. Such monitors are used for outputting the obtained image, on which the image is subjected to checking, controlling, or any other image processing, before being used for actual diagnosis or reproduced onto a film.

When reproducing the image captured by the medical diagnostic apparatus onto a film, or reproducing the image obtained by the above-described medical diagnosis and/or measuring apparatus onto a film, a monochrome film having a blue base is often used. In many cases, such images are reproduced in 10-bit gradation level resolution (1024 gradation levels).

However, in those color CRT displays described above, images are typically displayed in 8-bit gradation level resolution. For example, in most color LCDs, 6-bit gradation level resolution is typically used for displaying images, and even in latest high-performance color LCDs, 8-bit gradation level resolution is typically used. Therefore, in a typical type of color display, images may be displayed at a lower gradation level resolution than that of the medical diagnosis and/or measurement apparatuses with which the images are captured. In other words, images may be displayed with less number of gradation levels.

Therefore, there may be a problem due to such lowered resolution. For example, if an original gray image that is represented in 10-bit gradation level resolution (i.e., 1024 gradation levels) is displayed using a color display device that has less number of monochrome gradation levels (e.g., 256×3 (RGB)), there may be certain gradation levels (levels other than multiples of 4) which are not represented by means of a simple graying operation. In particular, the problem becomes more profound if critical diagnostic information is hidden in those levels.

In addition, the above described lowered resolution problem may result in artifacts, a kind of noise in a contour shape. Such noises may significantly reduce the reliability of diagnosis and are unacceptable for medical diagnostic images.

In order to solve the foregoing problems, it has been proposed to use a time divisional approach (such as, frame rate control (FRC) method). For example, according to the FRC method, 10-bit image data is divided into four units of 8-bit image data. Each unit of data is displayed sequentially by raising the frequency, thus achieving 10-bit gradation level representation on an 8-bit color display.

However, displaying images based on the FRC method may have a problem of flickering (flickering of screen). In order to eliminate flickering, the frame frequency needs to be raised, and high speed switching is required. However, there are limitations of the response speed of the driver IC of the monitor, as well as of the monitor itself.

On the other hand, some display devices used for medical diagnosis described above, employ a high definition image display scheme, for example, QSXGA (2560 pixels×2048 pixels) in which the number of pixels is increased to achieve higher image quality. In such cases, the response speed problem becomes particularly significant.

For such problems, a method proposed in co-pending U.S. patent application Ser. No. 09/617,308 (U.S. Ser. No. 09/617,308) “Image display method and image display device used for the method” corresponding to Japanese Patent Application Number 11-201667 (JP 2001-34232 A), assigned by the present assignee may be advantageously used.

This method is to correlate a minimum value and a maximum value of inputted data to an approximately minimum luminance value and an approximately maximum luminance value obtainable by combination of R, G, and B.

### SUMMARY OF THE INVENTION

The method disclosed in U.S. Ser. No. 09/617,308, however, may have a potential for improvement, because multi-gradation level display is achieved by changing each luminance value of R, G, and B according to a predetermined sequence when combining the luminance values for R, G, and B. As a result, pixels may undesirably be colored, though slightly, with a specific color (in cases other than luminance level of R=luminance level of G=luminance level of B) (Refer to TABLE 1 in U.S. Ser. No. 09/617,308).

The present invention has been made in order to eliminate the foregoing drawbacks and an object of the present invention is to provide an image display method through which multi-gradation level gray images for medical use can be displayed as a high definition display image suitable for diagnosis, in other words, the number of gradation levels that can be displayed is increased.

Accordingly, one object of the present invention is to provide an image display method that enables a common color display device (i.e., a device for displaying an 8-bit image in color) to display an image in appropriate gray gradations by making best use of luminance resolutions for respective colors which are inherent in the color display device, while preventing pixels from being undesirably colored with a specific color.

More specifically, one object of the present invention is to provide an image display method that enables a common color display device to display a gray image captured and generated by a CR (Computed Radiography), or other modalities that have been increasingly used in this field recently, with the gradation levels being suitably reproduced while preventing degraded images that might be caused due to less number of gradation levels, thus allowing appropriate and accurate diagnosis to be conducted.

In order to attain the object described above, a first aspect of the present invention is to provide an image display method for displaying a gray image using a color display device having a pixel formed by color cells, the method comprising the steps of: giving multi-gradation level gray image data that requires a higher gradation representation capability than a gradation representation capability of the color display device; and determining from a gray gradation level signal value represented by the multi-gradation level gray image data, a luminance value for each of the color cells to display the gray gradation level signal value; wherein the color display device displays each of the color cells using the determined luminance value. In particular, the present invention is to provide an image display method for displaying a gray image using a color display device having a pixel formed by R, G, and B cells, the method comprising the steps of: when multi-gradation level gray image data that requires a higher gradation representation capability than a gradation representation capability of said color display device is inputted, obtaining, from a gradation level signal (gray value) of the inputted multi-gradation level gray image data, a luminance value for each of the R, G, and B cells to display the gray value, and driving the color display device to display R, G, and B cells using the obtained luminance values.

Preferably, when the luminance value for each of the color cells to display the gray gradation level signal value is determined from the gray gradation level signal value represented by the multi-gradation level gray image data, the luminance value for each of the color cells is determined by obtaining a luminance value in a cell of an N color on the color display device where N is each color of the color cells, from ColorToGray_N (gray gradation level signal value) which is a function for determining a luminance value for each of the cells to represent appropriate gray from the gray gradation level signal value required by the multi-gradation level gray image data.

Preferably, the color cells are R, G and B cells. In addition, preferably, when a luminance value for each of the R, G and B cells to display the gray gradation level signal value is determined from the gray gradation level signal value represented by the multi-gradation level gray image data, the luminance value for each of the R, G and B cells is determined by, for example, obtaining the luminance value for the R cell on the color display device from ColorToGray_R (gray gradation level signal value), the luminance value for the G cell on the color display device from ColorToGray_G (gray gradation level signal value), and the luminance value for the B cell on the color display device from ColorToGray_B (gray gradation level signal value), respectively. Here, ColorToGray_N (gray gradation level signal value) (N is one of R, G, and B) is a function for determining the luminance value for each of the cells in order to represent appropriate gray from the gray gradation level signal value required by the multi-gradation level gray image data.

And, preferably, the luminance value for each of the color cells is determined as each voltage value for driving each of the color cells, and the color display device drives each of the color cells at each voltage value determined for each of the color cells to display each of the color cells at the luminance value.

A second aspect of the present invention is to provide the image display method according to the first aspect in which, preferably, when an image display signal to be imparted to each of the color cells is inputted, if a difference between image display signals imparted to two of the color cells is not more than a specified threshold value in any color cell pair in all pixels in a full screen or in a certain window, original multi-gradation level gray image data is obtained through inverse operation from the image display signals in the color cells of each pixel, and the luminance value for each of the color cells to display the gray gradation level signal value is determined from the gray gradation level signal value representing the multi-gradation level gray image data obtained by the inverse operation, and the color display device displays each of the color cells using the determined luminance value.

Preferably, the image display signal is a quasi-multi-gradation level gray image display signal obtained by converting the inputted image data into a luminance value representing the multi-gradation level gray image data using a characteristic curve relating image data to luminance value and substantially equally allocating the resulting luminance value for the luminance value of a color in each of the color cells.

Preferably, the color cells are R, G and B cells. In addition, preferably, a luminance value for each of the R, G, and B cells to display the gray gradation level signal value is determined from the gray gradation level signal value of the original multi-gradation level gray image data which is obtained through the inverse operation from the image display signals in the R, G, and B cells in each pixel, if the image display signals satisfy: |R−G|≦S, |R−B|≦s, and |G−B|≦s (where, s: a predetermined threshold value), and the color display device displays the R, G, and B cells using the determined luminance value.

In other words, the present invention provides an image display method for displaying a gray image using a color display device having a pixel formed by R, G, and B cells, the method comprising the steps of: when a signal (quasi-multi-gradation level gray image display signal) that converts inputted image data into a predetermined luminance value by using a characteristic curve that correlates image data and a specific luminance value, and allocates each obtained luminance value to R, G, and B luminance values substantially equally, is inputted, obtaining, from a gradation level signal value (gray value) of original multi-gradation level gray image data which is obtained through inverse operation from the quasi-multi-gradation level gray image display signal, a luminance value for each of the R, G, and B cells to display the gray value, if |R−G|≦s, and |R−B|≦s, and |G−B|≦s (where, s: a predetermined threshold value) are satisfied, and driving the color display device to display R, G, and B cells using the obtained luminance values.

A third aspect of the present invention is to provide the image display method according to the first aspect in which, preferably, when an image display signal to be imparted to each of the color cells is inputted, if a difference between image display signals imparted to two of the color cells is not more than a specified threshold value in any color cell pair in a rectangular region within an image to be displayed on the color display device, original multi-gradation level gray image data is obtained through inverse operation from the image display signals in the color cells of each pixel within the rectangular region, and the luminance value for each of the color cells to display the gray gradation level signal value is determined from the gray gradation level signal value representing the multi-gradation level gray image data obtained by the inverse operation, and the color display device displays each of the color cells using the determined luminance value.

Preferably, the image display signal is a quasi-multi-gradation level gray image display signal obtained by converting the inputted image data into a luminance value representing the multi-gradation level gray image data using a characteristic curve relating image data to luminance value and substantially equally allocating the resulting luminance value for the luminance value of a color in each of the color cells.

Preferably, the color cells are R, G and B cells. In addition, preferably, a luminance value for each of the R, G, and B cells to display the gray gradation level signal value is determined from the gray gradation level signal value of the original multi-gradation level gray image data which is obtained through the inverse operation from the image display signals in the R, G, and B cells in each pixel within the rectangular region of the image, if the image display signals satisfy: |R−G|≦s, |R−B|≦s, and |G−B|≦s (where, s: a predetermined threshold value), and the color display device displays the R, G, and B cells using the thus determined luminance value.

In other words, the present invention provides an image display method for displaying a gray image using a color display device having a pixel formed by R, G, and B cells, the method comprising the steps of: when a signal (quasi-multi-gradation level gray image display signal) that converts inputted image data into a predetermined luminance value by using a characteristic curve that correlates image data and a specific luminance value, and allocates each obtained luminance value to R, G, and B luminance values substantially equally, is inputted, obtaining, from a gradation level signal value (gray value) of original multi-gradation level gray image data which is obtained through inverse operation from the quasi-multi-gradation level gray image display signal, a luminance value for each of the R, G, and B cells for pixels included in a rectangular region to display the gray value, if |R−G|≦s, and |R−B|≦s, and |G−B|≦s (where, s: a predetermined threshold value) are satisfied for the pixels included in the rectangular region, and driving the color display device to display R, G, and B cells using the obtained luminance values.

Preferably, when a luminance value for each of the R, G and B cells to display the gray value is determined from the gradation level signal value (gray value) of the original multi-gradation level gray image data which is obtained through the inverse operation, the luminance value for each of the R, G and B cells is determined by obtaining the luminance value for the R cell on the color display device from ColorToGray_R (gray gradation level signal value), the luminance value for the G cell on the color display device from ColorToGray_G (gray gradation level signal value), and the luminance value for the B cell on the color display device from ColorToGray_B (gray gradation level signal value), respectively.

Here, ColorToGray_N (gray gradation level signal value) (N is one of R, G, and B) is a function for determining the luminance value for each of the cells in order to represent appropriate gray from the gray gradation level signal value required by the multi-gradation level gray image data.

The signal (quasi-multi-gradation level gray image display signal) for converting inputted image data into a predetermined luminance value by using a characteristic curve that correlates image data and a luminance value, and for allocating each obtained luminance value to R, G, and B luminance values substantially equally, is exemplified by the signal described in U.S. Ser. No. 09/617,308 which correlates a minimum value of the inputted image data to a substantially minimum value of the color display device, and a maximum value of the inputted image data to a substantial maximum luminance value of the color display device, and then converts the image data existing between the substantial minimum luminance value and the substantial maximum luminance value into appropriate luminance values by using a characteristic curve that correlates image data and a luminance value, and allocate each obtained luminance value to R, G, and B, substantially equally.

In this manner, according to the present invention, a significant effect can be obtained by providing an image display method in which a gray image used in medical field can be displayed as a high definition display image suitable for diagnosis; in other words, can be displayed with increased number of gradation levels.

In other words, according to the present invention, a practical effect can be obtained, in which an image display method is provided to enable a common color display to perform appropriate gray gradation level displaying by making best use of luminance resolutions for respective colors which are inherent in the color display device while preventing the pixels from being undesirably colored with a specific color.

More specifically, according to the present invention, an effect can be obtained, in which an image display method is provided to enable a color display device to suitably reproduce, as a diagnosis image, a gray image captured and generated by a CR (Computed Radiography), or other modalities that have been increasingly used in this field recently, with the gradation levels being suitably reproduced while preventing degraded images that might be caused by less gradation levels, thus allowing appropriate and accurate diagnosis to be conducted.

### BRIEF DESCRIPTION OF THE DRAWINGS

In the accompanying drawings:

FIG. 1 is a schematic view of an image display device according to one embodiment of the present invention, in which the image display device is used as a monitor of a medical diagnostic apparatus;

FIGS. 2A and 2B are partial enlarged views of a display screen of a color liquid crystal panel provided in the image display device shown in FIG. 1;

FIG. 3 shows an example of a characteristic curve correlating an image data value and a luminance value;

FIG. 4 is a chart explaining a conventional quasi-multi-gradation level display mode;

FIG. 5 is a block diagram showing a configuration of a data processing unit in the image display device shown in FIG. 1;

FIG. 6 is a flowchart (flowchart 1) explaining operation of a data processing unit according to the embodiment shown in FIG. 5; and

FIG. 7 is a flowchart (flowchart 2) explaining operation of a data processing unit according to the embodiment shown in FIG. 5.

### DETAILED DESCRIPTION OF THE INVENTION

Certain aspects of the present invention will hereinafter be described in detail on the basis of preferred embodiments shown in the accompanying drawings.

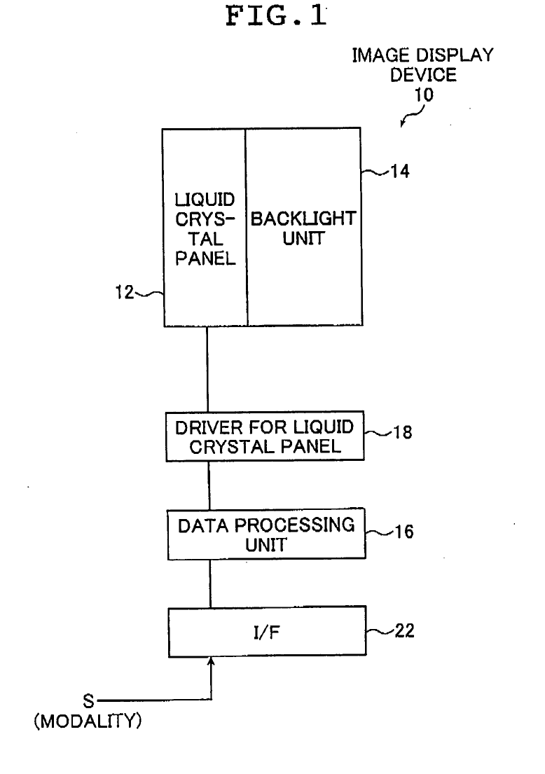

FIG. 1 is a schematic view of an image display device according to one embodiment of the present invention, in which the image display device is used as a monitor for a medical diagnostic apparatus.

An image display device 10 shown in FIG. 1, which is based on LCD, includes a color liquid crystal panel 12 for displaying an image using liquid crystals, a backlight unit 14, a data processing unit 16 for carrying out data processing which will be described later, a driver 18 for the color liquid crystal panel 12, and an interface (I/F) 22.

The image display device 10 according to this embodiment, which is constituted as described above, is connected with an image capturing unit (modality) S of a medical diagnostic apparatus such as an X-ray diagnostic apparatus, MRI diagnostic apparatus, or CT device, as a source for supplying diagnostic images, through the interface 22, so that image data is supplied to the image display device 10 from the image capturing unit S.

As the color liquid crystal panel for the LCD of the image display device according to the present invention, any well-known color liquid crystal panel generally used in various LCDs may be used without any particular limitation. As the operation mode, any well-known operation mode such as TN (Twisted Nematic), STN (Super Twisted Nematic), or MVA (Multi-domain Vertical Alignment) may be used.

The backlight unit 14 is employed for emitting backlight when observing the images displayed on the color liquid crystal panel 12, and is similar in configuration to the backlight unit of the well-known LCD. It is preferable for the image display device 10 to have the maximum luminance level in a range of 500-5000 cd/m², so as to be advantageously used as a monitor for medical use.

In the following paragraphs, first, general description of a method of displaying gray images using a color display device will be given based on an example described in U.S. Ser. No. 09/617,308. Then, new functions of the data processing unit 16 will be explained in detail.

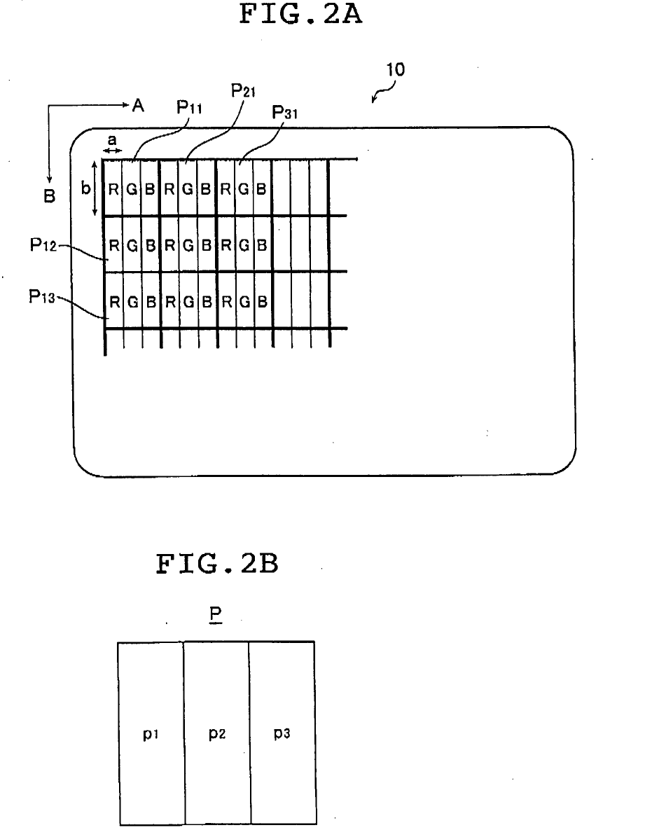

FIGS. 2A and 2B show partial enlarged views of a display screen of the color liquid crystal panel 12. As shown in FIG. 2A, each pixel in the display screen of the color liquid crystal panel 12 is formed of, in general, R cell, G cell, and B cell (hereinafter referred to as the R sub-pixel, G sub-pixel, and B sub-pixel) that are arranged in the horizontal direction (i.e., arrow A direction), when a color filter is used. When displaying a color image as in the usual case, R, G, and B sub-pixels are displayed using R, G, and B image data respectively. On the other hand, when displaying a gray image, these sub-pixels are used in such a manner as will be described in the following paragraphs so as to achieve a high definition gray image.

The color display device exemplified here uses a group (pixel) formed by R, G, and B sub-pixels shown in FIG. 2A, as a pixel to display a gray image. It should be noted that since one pixel is formed of R, G, and B sub-pixels when a color filter is used, the number of luminance values that can be displayed by one pixel is a triple of the number of luminance values that can be displayed by each of the R, G, and B sub-pixels.

In addition, the display device described in Japanese Patent Application No. 2006-183812, “image display method and image display device” proposed by one of the present inventors, utilizes two factors, one of which is each of the R, G, and B sub-pixels provided in the color display device, and the other is the human eye's visual perception capability specific to each color among R, G, and B colors, to improve the number of gradation levels that can be visually perceived by human eyes, so that a high quality image is displayed by reproducing the supplied original image with higher resolution.

Specifically, when displaying a monochrome image on a color display device, each of the R, G, and B sub-pixels is usually driven by the same image data. For example, when displaying 10-bit image data of 513, 9-bit color image data of (256, 256, 256) is used. And, data for each of the R, G, and B sub-pixels is increased by one gradation level to (257, 257, 257), thus increasing gray data of 256 to 257.

As described above, the sub-pixels of the display 18 can be modulated and driven independently to each other. By utilizing such capability, it is possible to increase the image data for one or two sub-pixels out of the R, G, and B sub-pixels by one (hereinafter, the phrase “to increase the gradation level by one level” or simply “to increase gradation level” means “to increase the gradation level of a sub-pixel by one level”) so that the luminance as perceived by human eyes can be improved and the image can be represented at a luminance level in the middle of 256 and 257. In other words, representation of the image can be differentiated within one gradation level.

In this case, change in luminance perceived by human eyes is different depending on color. Such change is different among the R, G, and B colors, which is roughly reported as R:G:B=10:5:2. Therefore, the degree of improvement (amount of change) in visually perceivable luminance can be selected/set by selecting which sub-pixel(s) to increase.

Specifically, change in the degree of visually perceived luminance (i.e., gradation level) achieved by increasing one gradation level depends on what color is selected out of the sub-pixels. For example, in the course of increasing from (+0, +0, +0) to (+1, +1, +1), if one is added to R sub-pixel only, like (+1, +0, +0), an amount of [5/17=0.29] is increased, thereby achieving an increase of 0.29 in terms of visual luminance. Therefore, selecting one or two from the sub-pixels to which one gradation level is added can control visually perceivable luminance (in other words, can achieve differentiation of the image within one gradation level). In this way, the certain gradation levels (image data) that would have been unable to display due to less displayable gradation levels, can be displayed.

TABLE 1 below summarizes visually perceivable luminance improvement, or a change amount in gradation level, attainable in total by one pixel within one gradation level, by adding one level to each sub-pixel. In TABLE 1, “1” given under R, G, and B indicates one gradation level increase in sub-pixel of each color, and “0” indicates no gradation level increase.

TABLE 1

| | | | Visual Luminance |
|---|---|---|---|
| G | R | B | Improvement |
| 0 | 0 | 0 | 0.00 |
| 0 | 0 | 1 | 0.12 |
| 0 | 1 | 0 | 0.29 |
| 0 | 1 | 1 | 0.41 |
| 1 | 0 | 0 | 0.59 |
| 1 | 0 | 1 | 0.71 |
| 1 | 1 | 0 | 0.88 |
| 1 | 1 | 1 | 1.00 |

When displaying a 10-bit original image (monochrome image) onto a 9-bit color display device, image data of odd number is not represented. Image data of 10-bit original image corresponds to middle (+0.5 gradation level) of one gradation level in 9 bits. If it is possible to represent such data using two levels of 1 and 1.5 within one gradation level, an image corresponding to the 10-bit monochrome image can be appropriately represented on a 9-bit color display device.

As shown in TABLE 1, adding one level to G sub-pixel only, allows an improvement of 0.59 gradation level in visual luminance within one gradation level of one pixel, which can be utilized to double the number of visually-perceivable gradation levels, and to allow representation of approximately middle level (0.5 gradation level) within one gradation level.

Specifically, for an original image having a gradation level of 512, the sub-pixels (R, G, B) of (256, 256, 256) are used, and for an original image having a gradation level of 513, the sub-pixels (R, G, B) of (256, 257, 256) with one level added to G sub-pixel are used. In the same manner, for an original image having a gradation level of 514, the sub-pixels (R, G, B) of (257, 257, 257) are used, and for an original image having a gradation level of 515, the sub-pixels (R, G, B) of (257, 258, 257) with one level added to G sub-pixel are used. Further, for an original image having a gradation level of 516, the sub-pixels (R, G, B) of (258, 258, 258) are used, and for an original image having a gradation level of 517, the sub-pixels (R, G, B) of (258, 259, 258) with one level added to G sub-pixel are used.

In this way, image data corresponding to an original image having a gradation level of 513 provides a visually-perceivable luminance of about 256.6, image data corresponding to an original image having a gradation level of 515 provides a visually-perceivable luminance of about 257.6, and image data corresponding to an original image having a gradation level of 517 provides a visually-perceivable luminance of about 258.6. Therefore it is possible to represent image data having a gradation level of odd number, such as 513, 515, 517, that may occur when converting a 10-bit monochrome image into a monochrome image to be reproduced onto a 9-bit color display, and that would have been unachievable using the conventional method.

As described above, up to 6 combinations are available (see TABLE 1) in increasing the luminance level of R, G, and B sub-pixels. By utilizing such combinations, up to seven gradation levels are achieved within one gradation level. In other words, it is possible to increase the visually perceivable luminance of the image to be displayed up to seven-times, thus allowing a number of changes in gradation levels to be achieved.

Now, referring back to the above description as to the group (pixel) formed by R, G, and B sub-pixels shown in FIG. 2A, description will be continued.

In the above embodiment, luminance values are set by reducing the interval between the values to 1/3, so that finer gradation levels are achieved when displaying the image. By utilizing this, the color display device exemplified here correlates the minimum and maximum values of the image data respectively to the minimum and maximum gradation values that can be displayed by one pixel in total, that is, the minimum and maximum luminance values available in the color display device, so that the gray image is displayed.

For example, when each of the three sub-pixels p1, p2, and p3 in FIG. 2B, performs 8-bit displaying, luminance values that can be displayed are in a range from 0 to 255 and the luminance values that can be displayed by the pixel P are in a range from 0 to 765 (=255×3). In this case, the minimum luminance value of 0 is associated with the minimum value (Min) of the image data, and the maximum luminance value of 255 is associated with the maximum value (Max) of the image data, so that a display image with high gradation levels can be obtained. The data processing unit 16, when supplying the luminance values converted from the image data to the pixel P, allocates substantially evenly to the three sub-pixels p1, p2, and p3.

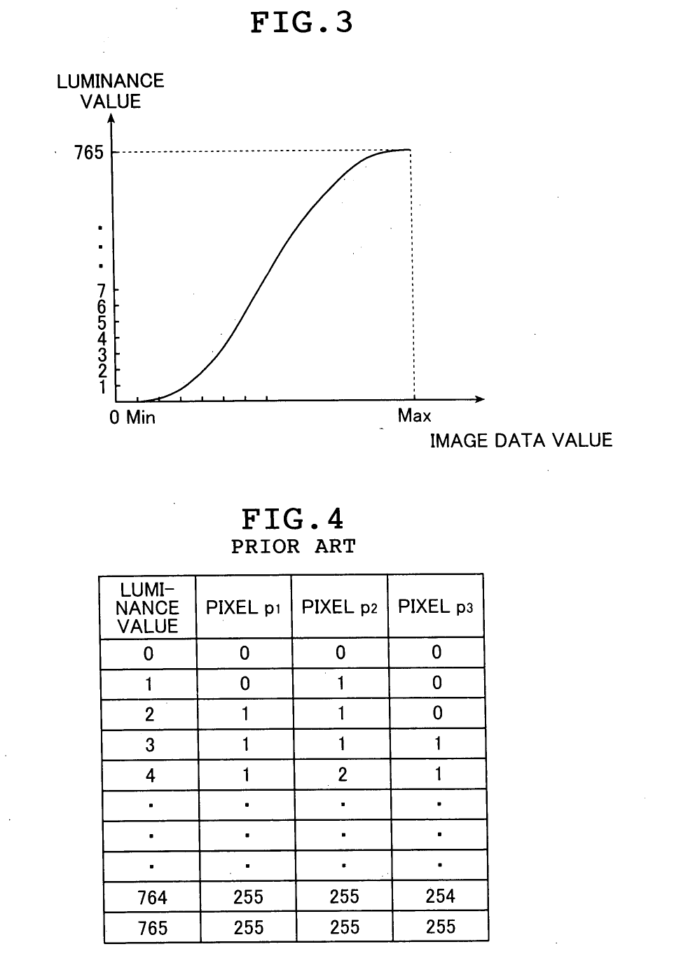

Specifically, when 8-bit image data is inputted to a color display device in which each of the sub-pixels p1, p2, and p3 displays in 8 bits, the image data that contains values of 0 to 255 is converted into 765 levels of luminance values in such a manner that the minimum value (Min) of the image data is associated with the minimum luminance value of 0 of the color display device, the maximum value (Max) of the image data is associated with the maxim luminance value of 765 of the color display device, and then luminance values between the maximum luminance value and the minimum luminance value are plotted as a characteristic curve in which the image data values and the luminance values are correlated, as shown in FIG. 3.

Then, the data processing unit 16 allocates a luminance value obtained from the data, to sub-pixels p1, p2, and p3 substantially evenly as shown in FIG. 4. For example, if the luminance value is 0, the data processing unit 16 allocates, 0, 0, 0; if the luminance value is 1, it allocates 0, 1, 0; if the luminance value is 2, it allocates 1, 1, 0; if the luminance value is 3, it allocates 1, 1, 1; if the luminance value is 4, it allocates 2, 1, 1; . . . if the luminance value is 764, it allocates 255, 255, 254; and if the luminance value is 765, it allocates 255, 255, 255.

As described above, by allocating the luminance values to sub-pixels p1, p2, and p3 approximately evenly, the image represented in 8 bits (i.e., represented in 256 gradation levels) can be represented by using 765 gradation levels, which means triple in gradation levels. According to this method, luminance unevenness in the pixel P is reduced, and visually high quality image can be displayed, so that the possibility in occurrence of false diagnosis is minimized.

The description of the quasi-multi-gradation level gray image display method provided in the foregoing paragraphs is mainly related to the example included in U.S. Ser. No. 09/617,308. In such method, as already explained, pixels may be undesirably colored with a specific color (in cases other than luminance level of R=luminance level of G=luminance level of B). In other words, even with such method as described in U.S. Ser. No. 09/617,308, in which the data processing unit 16 allocates the luminance value obtained from the image data substantially evenly as shown in FIG. 4, a multi-gradation level gray image display method of a satisfactory level may not be achieved.

In view of the foregoing, an image display method according to this embodiment, has the data processing unit 16 that employs a different approach from the one described in U.S. Ser. No. 09/617,308 and the one described in Japanese Patent Application No. 2006-183812 for carrying out gray display (gray image display) of inputted image data. Detailed description will be given in the following paragraphs.

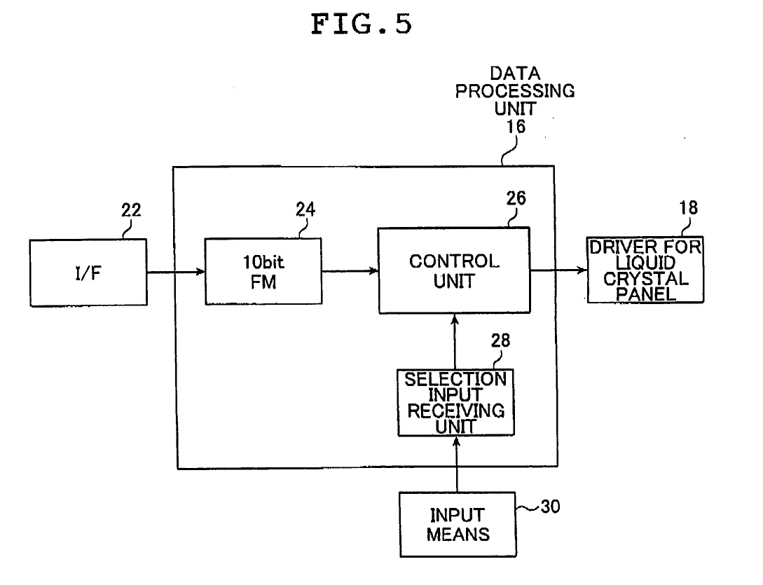

FIG. 5 shows a block diagram of the data processing unit 16. As shown in FIG. 5, the data processing unit 16 has a function for selecting a process. With this function, gray image data represented in 10-bit representation, when inputted, can be displayed with a preferable image quality (specifically, pixels can be represented with an appropriate gray gradation level without being undesirably colored with a specific color) even by an image display device only capable of displaying 8-bit gradation level representation.

The data processing unit 16 shown in FIG. 5 includes a 10-bit frame memory 24, a control unit 26, and a selection input receiving unit 28. The control unit 26 selects one from a plurality of processing methods previously set and performs data conversion as necessary. The selection input receiving unit 28 receives a selection input regarding a mode for multi-gradation level gray image display inputted by an operator (through input means 30). A color liquid crystal panel driver 18 having a luminance setting function, which will be described later, is provided for receiving output from the data processing unit 16.

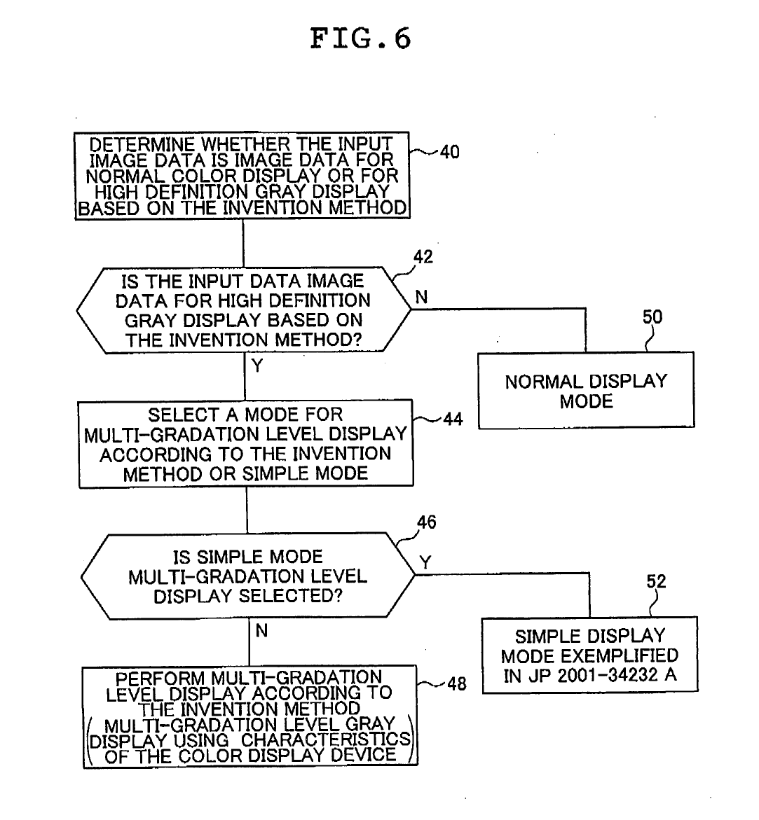

FIG. 6 shows a flowchart of one example of operation (i.e., function of control unit 26) of the data processing unit 16 constituted as described above.

As shown in FIG. 6, when image data is inputted in the image display device, it is first determined whether the data is for normal color display, or for multi-gradation level gray display in which a quasi-method as proposed in the present invention is used (Step 40).

Preferred methods for determining whether the inputted image data is for multi-gradation level gray display or not, as described above, include, for example, a method in which all the pixels in a full screen or in a certain window are examined whether the R, G and B image display signals, for example, the quasi-multi-gradation level gray image display signals satisfy the following condition or not:

|R−G|≦s, |R−B|≦s, and |G−B|≦s (where, s: a predetermined threshold value).

If the condition is satisfied, then the inputted data is determined as the image data for multi-gradation level gray display. In this case, “s” may be set to 1, for example.

In another method that can be preferably used for the determination, pixels in a rectangular region in the image are examined whether the R, G and B image display signals, for example, the quasi-multi-gradation level gray image display signals satisfy the following condition or not: |R−G|≦s, |R−B|≦s, and |G−B|≦s (where, s: a predetermined threshold value). If the condition is satisfied, then the inputted data is determined as the image data for multi-gradation level gray display. Processing in this case will be described later in detail.

In addition, there may be cases in which the image as a whole may not be determined as a gray image, even if it is monochrome. For example, images may be blue monochrome, as in the case of X-ray films having blue base color. Considering such cases, another method is also preferably used in which, when,

### DRG=R−G, DRB=R−B, DGB=G−B,

if the difference between the maximum value and the minimum value for each of DRG, DRB, DGB is 1 or less, the image is determined as monochrome, and is processed in the same way as the gray image.

Alternatively, determination in Step 40 may be performed by manually through a selection switch mounted on the monitor (image display device), rather than performing automatically as described above.

Now referring back to FIG. 6, description will be continued.

If the result of the determination in Step 40 indicates that the image data inputted in the image display device is for multi-gradation level gray display according to the quasi-method proposed in the present invention (Y in Step 42), the multi-gradation level gray image display according to the quasi-method is to be performed. Next step is to determine a mode to be used for displaying multi-gradation level gray image, by selecting either one of the simple display mode (for example, the method described in U.S. Ser. No. 09/617,308) and the display mode with prevention of undesirable pixel coloring (i.e., the mode newly proposed in the present invention)(Step 44).

As the selection method, a method including operator's determination is employed in this embodiment as an example. For such case, input means 30 is provided for the operator to input their determination, and the data processing unit 16 monitors input through the selection input receiving unit 28. The data processing unit 16 sends any input if received to the control unit 26.

Instead of inputting operator's determination each time, this determination can be set to as a default. For example, the default may be set to the newly proposed display technique with prevention of pixel coloring, so that the simple mode (the mode described in U.S. Ser. No. 09/617,308) is not used in principle and the newly proposed display mode with prevention of pixel coloring is used unless special condition is given. It should be appreciated that the method including the selection step is explained here as general description.

If the simple mode of one such described in U.S. Ser. No. 09/617,308 is selected in Step 46 (Y in Step 46), process proceeds to Step 52 to perform quasi-multi-gradation level gray image display through the operation in the data processing unit 16 as described. On the other hand, if the newly proposed mode is selected, multi-gradation level gray image display with prevention of pixel coloring is performed (Step 48) in the following manner.

The multi-gradation level gray image display with prevention of pixel coloring, shown in Step 48 is, in essence, a mode in which an instruction is issued from the data processing unit 16 to determine each luminance value of R sub-pixel, G sub-pixel, and B sub-pixel based on a prerequisite that a pixel is displayed in gray with the luminance values of R, G, B being always balanced. This is accomplished by using a luminance setting function of the driver 18 for the color liquid crystal panel 12.

For example, in order to obtain the luminance value for each of the R, G, B cells to display the gray value from the gradation level signal value (gray value) of the multi-gradation level gray image data to be displayed, the luminance value of R cell on the color display device, the luminance value of G cell on the color display device, and the luminance value of B cell on the color display device may be determined from ColorToGray_R (gradation level signal value), ColorToGray_G (gradation level signal value), and ColorToGray_B (gradation level signal value), respectively, where ColorToGray_N (gradation level signal value) (N is one of R, G, and B) is a function for obtaining a luminance value for each cell (depending on the driving voltage and the characteristics of the color device) in order to represent appropriate gray from the gradation level signal value.

In the present invention, ColorToGray_N (gradation level signal value) (where N is either one of R, G, and B) represents the relationship between the input voltage (which is proportional to the gradation level signal value (hereinafter, also referred to simply as gradation value)) at the RGB terminal of the color display device (monitor) and the luminance value of the corresponding pixel of the monitor, and for the sake of convenience in explaining, a form of function is used.

If a CRT monitor is used, the relationship between the voltage and the luminance value is physically determined, for example, as:

I=kE^{γ} (where I is luminance value, E is signal voltage, K is proportionality constant, and ^{γ} is gradation level). That is, in case of a CRT monitor, such relationship is simply represented by the above function. Recent LCD displays, on the other hand, have various different configurations, and accordingly there are various types of relationship between the voltage of the LCD cell and the luminance value. Moreover, in some display modes, the luminance value is controlled not only by a simple method, but also by several methods to achieve total effect, for example, by driving cells like a shutter, or driving cells time divisionally. Therefore, it is not a practical way to simply (or at least arithmetically) determine the relationship. As one solution to this is using a LUT stored inside the LCD display to convert the relationship between voltage and luminance in a similar way as in the case of a CRT monitor. Or a specific LUT is used to determine the relationship indifferently to a CRT monitor (more suitable for medical use). In this way, since there are various different types of relationship between voltage and luminance, it would be better not to dig into the detail of the relationship in this description, and better to leave it as a function as described above.

The content of ColorToGray_N will be explained below with reference to the attached TABLE 2 and TABLE 3 in which some ColorToGray_N functions are shown, as examples. In particular, TABLE 2 shows the function of the present invention, while TABLE 3 shows the function in the referred method disclosed in Japanese Patent Application No. 2006-183812, and JP 2001-34232 A.

Although there are various types of ColorToGray_N functions some of which are not able to be represented by a general formula, as described above, for simplification, the functions are considered as a physical amount proportional to the luminance value (or more simply, the function may be considered as a value proportional to the voltage). While the relationship between the gradation value of R, G, B and the physical amount of ColorToGray_R(R), ColorToGray_G(G), ColorToGray_B(B) varies among the gradation values R, G, and B, it is assumed that the relationship between the gradation value and ColorToGray_N (gradation value) is proportional, with a certain offset value (i.e., liner primary function). Also, as described in conjunction with TABLE 1 above, the proportionality factor of G is the smallest, the proportionality factor of R is 2 times of that of G, and the proportionality factor of B is 10 times of that of G.

TABLE 2
FUNCTION OF INVENTIVE EXAMPLE

| Luminance Value | | | | | | |
|---|---|---|---|---|---|---|
| (Gray value to | | | | | | |
| be displayed) | R | G | B | ColorToGray_R(R) | ColorToGray_G(G) | ColorToGray_B(B) |
| 390 | 130 | 130 | 130 | 2.03 | 5.31 | 3.05 |
| 391 | 131 | 130 | 130 | 2.05 | 5.32 | 3.15 |
| 392 | 130 | 131 | 131 | 2.07 | 5.33 | 3.25 |
| 393 | 131 | 131 | 131 | 2.09 | 5.34 | 3.35 |

TABLE 3
FUNCTION OF REFERENCE EXAMPLE

| Luminance Value | | | | | | |
|---|---|---|---|---|---|---|
| (Gray value to | | | | | | |
| be displayed) | R | G | B | ColorToGray_R(R) | ColorToGray_G(G) | ColorToGray_B(B) |
| 390 | 130 | 130 | 130 | 2.03 | 5.31 | 3.05 |
| 391 | 131 | 130 | 130 | 2.09 | 5.31 | 3.05 |
| 392 | 130 | 131 | 131 | 2.03 | 5.34 | 3.35 |
| 393 | 131 | 131 | 131 | 2.09 | 5.34 | 3.35 |

Based on the above described prerequisites, the referred method will be described first.

In a typical monitor, when displaying gray, each same value is used for R, G, and B, resulting in only 256 gradation levels being obtained. In order to solve the problem, the referred method increases/decreases the value of either one of R, G, and B by one to finely increase the total number of luminance values that can be set. However, each of the sub-pixels R, G, B is driven by each physical amount corresponding to each luminance value, allowing no other values to be used. Such value is:

in case of R, 2.03 or 2.09,

in case of G, 5.31 or 5.34, and

in case of B, 3.05 or 3.35.

As a result, while three times of 256 gradation levels can be displayed as the luminance value, each sub-pixel can represent only 256 gradation levels, which may cause the gray balance to be degraded depending on combination.

The present invention is to eliminate such drawbacks. In the present invention, a region in which the gradation values R, G, and B are not the same value but the difference among them is negligible (for example, less than 1 as the absolute value) is considered as gray, and values other than the values available in the referred method can be selected in order to achieve three times finer luminance setting for each sub-pixel, and eliminate any degraded gray balance. The values that can be selected are:

in case of R, 2.05, 2.07, in addition to 2.03, 2.09

in case of G, 5.32, 5.33, in addition to 5.31, 5.34, and

in case of B, 3.15, 3.25, in addition to 3.05, 3.35.

### Accordingly, the luminance value of each of the R, G, B sub-pixels can be set independently to each other at an interval of three times finer than that of 256 gradation levels.

In addition, conversion is not performed one to one for each of the R, G, B values using ColorToGray_R(R), ColorToGray_G(G), ColorToGray_B(B), independently. Instead, considering that a set of R, G, B as a gradation value corresponding to LULMINANCE VALUE, each optimum physical amount is allocated to each of the sub-pixels R, G, B, while preventing the gray balance from being degraded. In this way, almost three times of 256 gradation levels can be displayed without degraded gray balance.

The driver 18 of the color liquid crystal panel 12 converts the luminance value obtained in the above procedure into a voltage value, and drives the color liquid crystal panel 12 with the obtained voltage value, so that the color liquid crystal panel 12 can produce a required luminance. In this way, the color liquid crystal panel 12 can display excellent multi-gradation level gray images with satisfactory number of gradation levels corresponding to 10-bit data, while preventing each pixel from being colored with a specific color. In other words, the luminance value of each of the color cells (R, G and B cells) in each pixel of the color liquid crystal panel 12 is determined as each voltage value for driving each of the color cells, and each of the color cells in each pixel of the color liquid crystal panel 12 is driven at each voltage value determined for each of the color cells, whereby an excellent multi-gradation level gray image can be displayed without coloration of each pixel to a specific color.

The aforementioned ColorToGray_N (gradation level signal value) for determining the luminance value of each cell to represent proper gray from the gradation signal value required by the multi-gradation level gray image data (depending on the driving voltage and the characteristics of the color device), more specifically, ColorToGray_R (gradation level signal value), ColorToGray_R (gradation level signal value) and ColorToGray_R (gradation level signal value), or the relationship between such gradation level signal value and the luminance value of each of the R, G and B cells on the color display device may be determined by conducting an experiment beforehand so that a correspondence table such as a look-up table (LUT) is prepared therefor. When converting the luminance values for R, G, and G into driving voltages, it is advantageous to previously obtain the relationship between them by for example conducting experiments, and store it as a correspondence table such as a LUT. However, the present invention is not limited to this. It should be appreciated that such relationship may also be obtained by conducting a simple and easy calculation as necessary.

In the following paragraphs, supplemental description will be given on the case (method of determining the multi-gradation level gray image data) described above in which a rectangular region of the image is selected as a region for examining the pixels. The pixels in a certain rectangular region in the image are examined whether the R, G and B image display signals, for example, the quasi-multi-gradation level gray image display signals satisfy the following condition or not:

|R−G|≦s, and |R−B|≦s, and |G−B|≦s (where, s: a predetermined threshold value).

### If the condition is satisfied, then the inputted data is determined as the multi-gradation level gray image data.

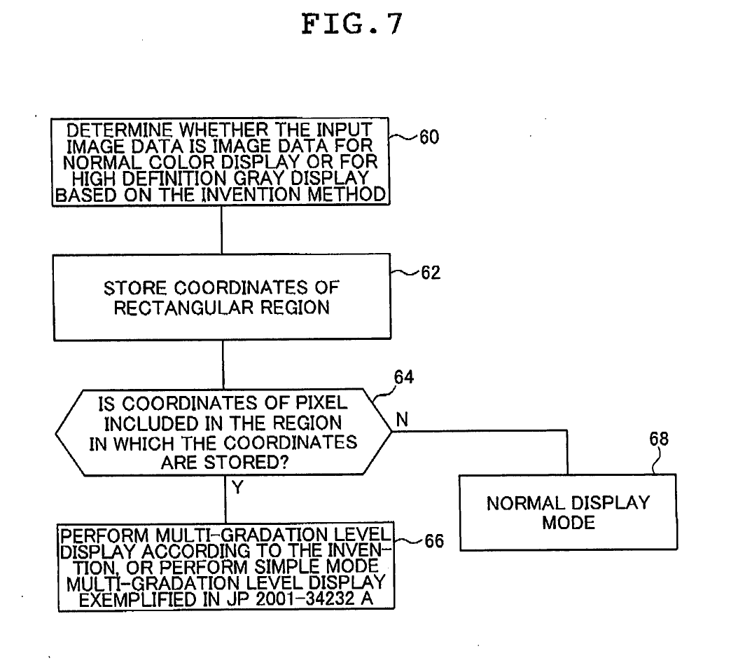

In this case, if the data in the certain rectangular region in the image is determined to be the multi-gradation level gray image data according to the quasi-method as proposed in the present invention, the processing shown in FIG. 7 is performed. In other words, only the pixels in the rectangular region are displayed according to Step 66 (display according to the mode proposed in the present invention, or display according to the mode exemplified in U.S. Ser. No. 09/617,308), and the pixels in other regions are displayed according to Step 68 (normal display mode).

This is particularly effective when one screen is divided into several regions and a monochrome (gray) image and a color image are mixetdly displayed.

More specifically, in Step 60 and Step 62 in FIG. 7, a rectangular region of which all the pixels satisfy the condition: |R−G|≦s, and |R−B|≦s, and |G−B|≦s (where, s: a predetermined threshold value), is retrieved. Then coordinates representing such rectangular region, for example, coordinates of lower left and upper right are stored in a memory as (x0, y0), (x1, y1).

In Step 64, if each pixel of the image is included in the rectangular region represented by (x0, y0), (x1, y1), process in Step 66 is performed, and if not, process in Step 68 is performed.

In addition, the number of rectangular regions is not limited to one, and a plurality of rectangular regions included in the image can be processed in the same way.

Moreover, while in the above description, a rectangular shape is used for clipping a certain region from a screen, it is not limited to rectangular, and any shape such as polygonal, circle, and free curve, may be used as long as position and coordinates are specified.

While embodiments of the invention have been illustrated and described, it will be apparent that the present invention is not limited to the embodiment described above, and various modifications can be made without departing from the spirit and scope of the invention.

For example, while the display device of LCD type is used in the embodiment, the present invention can be implemented on other type of display devices in the same manner.

Further, in the above description, the present invention has been explained using a color display device having cells of R, G, and B (i.e., three colors). However, the present invention is not limited to this, but any device may be employed as long as a plurality of colors capable of color display, in other words, a plurality of color cells capable of color display are used. For example, it is apparent that a color device using three colors other than R, G, B, or using cells of colors other than the three colors may also be used without any particular modification.

What is claimed is:

1. An image display method for displaying a gray image using a color display device having a pixel formed by color cells, the method comprising the steps of:
giving multi-gradation level gray image data that requires a higher gradation representation capability than a gradation representation capability of the color display device; and
determining from a gray gradation level signal value represented by the multi-gradation level gray image data, a luminance value for each of the color cells to display the gray gradation level signal value;
wherein the color display device displays each of the color cells using the determined luminance value.

2. The image display method according to claim 1, wherein, when the luminance value for each of the color cells to display the gray gradation level signal value is determined from the gray gradation level signal value represented by the multi-gradation level gray image data, the luminance value for each of the color cells is determined by obtaining a luminance value in a cell of an N color on the color display device where N is each color of the color cells, from ColorToGray_N (gray gradation level signal value) which is a function for determining a luminance value for each of the cells to represent appropriate gray from the gray gradation level signal value required by the multi-gradation level gray image data.

3. The image display method according to claim 1, wherein the color cells are R, G and B cells, and when a luminance value for each of the R, G and B cells to display the gray gradation level signal value is determined from the gray gradation level signal value represented by the multi-gradation level gray image data, the luminance value for each of the R, G and B cells is determined by obtaining the luminance value for the R cell on the color display device from ColorToGray_R (gray gradation level signal value), the luminance value for the G cell on the color display device from ColorToGray_G (gray gradation level signal value), and the luminance value for the B cell on the color display device from ColorToGray_B (gray gradation level signal value), respectively, where ColorToGray_N (gray gradation level signal value) (N is one of R, G, and B) is a function for determining the luminance value for each of the cells in order to represent appropriate gray from the gray gradation level signal value required by the multi-gradation level gray image data.

4. The image display method according to claim 1, wherein the luminance value for each of the color cells is determined as each voltage value for driving each of the color cells, and the color display device drives each of the color cells at each voltage value determined for each of the color cells to display each of the color cells at the luminance value.

5. The image display method according to claim 1,
wherein, when an image display signal to be imparted to each of the color cells is inputted, if a difference between image display signals imparted to two of the color cells is not more than a specified threshold value in any color cell pair in all pixels in a full screen or in a certain window, original multi-gradation level gray image data is obtained through inverse operation from the image display signals in the color cells of each pixel, and the luminance value for each of the color cells to display the gray gradation level signal value is determined from the gray gradation level signal value representing the multi-gradation level gray image data obtained by the inverse operation, and
wherein the color display device displays each of the color cells using the determined luminance value.

6. The image display method according to claim 5, wherein the image display signal is a quasi-multi-gradation level gray image display signal obtained by converting the inputted image data into a luminance value representing the multi-gradation level gray image data using a characteristic curve relating image data to luminance value and substantially equally allocating the resulting luminance value for the luminance value of a color in each of the color cells.

7. The image display method according to claim 5,
wherein the color cells are R, G and B cells, and a luminance value for each of the R, G, and B cells to display the gray gradation level signal value is determined from the gray gradation level signal value of the original multi-gradation level gray image data which is obtained through the inverse operation from the image display signals in the R, G, and B cells in each pixel, if the image display signals satisfy:

|R−G|≦s, |R−B|≦S, and |G−B↑≦s
(where, s: a predetermined threshold value), and
wherein the color display device displays the R, G, and B cells using the determined luminance value.

8. The image display method according to claim 1,
wherein, when an image display signal to be imparted to each of the color cells is inputted, if a difference between image display signals imparted to two of the color cells is not more than a specified threshold value in any color cell pair in a rectangular region within an image to be displayed on the color display device, original multi-gradation level gray image data is obtained through inverse operation from the image display signals in the color cells of each pixel within the rectangular region, and the luminance value for each of the color cells to display the gray gradation level signal value is determined from the gray gradation level signal value representing the multi-gradation level gray image data obtained by the inverse operation, and
wherein the color display device displays each of the color cells using the determined luminance value.

9. The image display method according to claim 8, wherein the image display signal is a quasi-multi-gradation level gray image display signal obtained by converting the inputted image data into a luminance value representing the multi-gradation level gray image data using a characteristic curve relating image data to luminance value and substantially equally allocating the resulting luminance value for the luminance value of a color in each of the color cells.

10. The image display method according to claim 8,
wherein the color cells are R, G and B cells, and a luminance value for each of the R, G, and B cells to display the gray gradation level signal value is determined from the gray gradation level signal value of the original multi-gradation level gray image data which is obtained through the inverse operation from the image display signals in the R, G, and B cells in each pixel within the rectangular region of the image, if the image display signals satisfy:

|R−G|≦s, |R−B|≦S, and |G−B|≦s
(where, s: a predetermined threshold value), and
wherein the color display device displays the R, G, and B cells using the thus determined luminance value.
